(19) United States
(12) Patent Application Publication
(10) Pub. No.: US 2026/0014811 A1
(43) Pub. Date: Jan. 15, 2026

(54) AZO-BF2-BASED ADAPTIVE FUNCTIONAL MATERIALS

(71) Applicant: Trustees of Dartmouth College, Hanover, NH (US)

(72) Inventors: Ivan Abrahamian, Hanover, NH (US); Qingkai Qi, Hanover, NH (US); Alexander Lippert, Dallas, TX (US)

(73) Assignees: Trustees of Dartmouth College, Hanover, NH (US); Southern Methodist University, Dallas, TX (US)

(21) Appl. No.: 19/139,623

(22) PCT Filed: Dec. 14, 2023
(86) PCT No.: PCT/US2023/083995

§ 371 Date: Jun. 16, 2025

Related U.S. Application Data
(60) Provisional application No. 63/432,616, filed on Dec. 14, 2022.

(51) Int. Cl. B41M 5/34; B41M 3/00

(52) U.S. Cl. CPC B41M 5/34; B41M 3/008

(57) ABSTRACT

Embodiments of the present disclosure pertain to a method of changing a color of one or more regions of a substrate by applying at least one stimulus to the one or more regions of the substrate. In some embodiments, the one or more regions of the substrate includes one or more compounds that facilitate the color change. Additional embodiments of the present disclosure pertain to the aforementioned compounds. Further embodiments of the present disclosure pertain to substrates that include the compounds of the present disclosure.

### CROSS-REFERENCE TO RELATED APPLICATIONS

This application claims priority to U.S. Provisional Pat. App. No. 63/432,616, filed on Dec. 14, 2022. The entirety of the aforementioned application is incorporated herein by reference.

### BACKGROUND

A need exists for improved adaptive materials that exhibit multi-chromic response as a function of applied stimulus. Numerous embodiments of the present disclosure address the aforementioned need.

### SUMMARY

In some embodiments, the present disclosure pertains to a method of changing a color of one or more regions of a substrate. In some embodiments, the methods of the present disclosure include applying at least one stimulus to the one or more regions of the substrate. In some embodiments, the one or more regions of the substrate includes one or more compounds that facilitate the color change. The substrates of the present disclosure can include various compounds that can facilitate color change. In some embodiments, the compounds of the present disclosure include, without limitation:

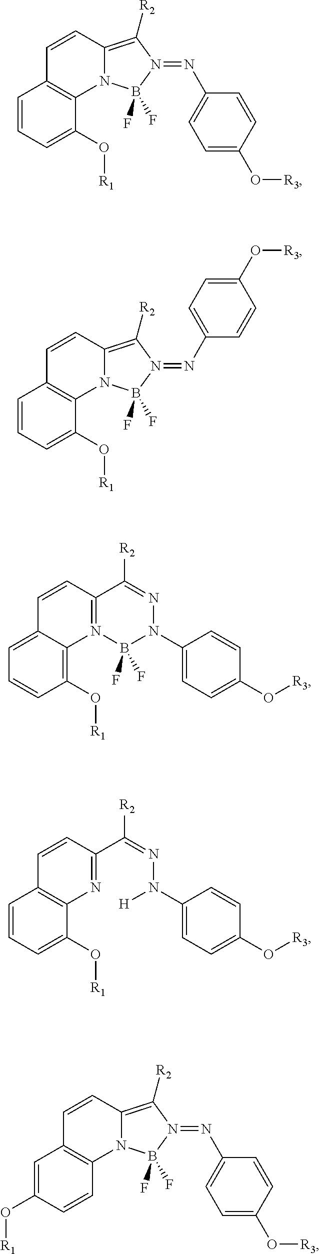

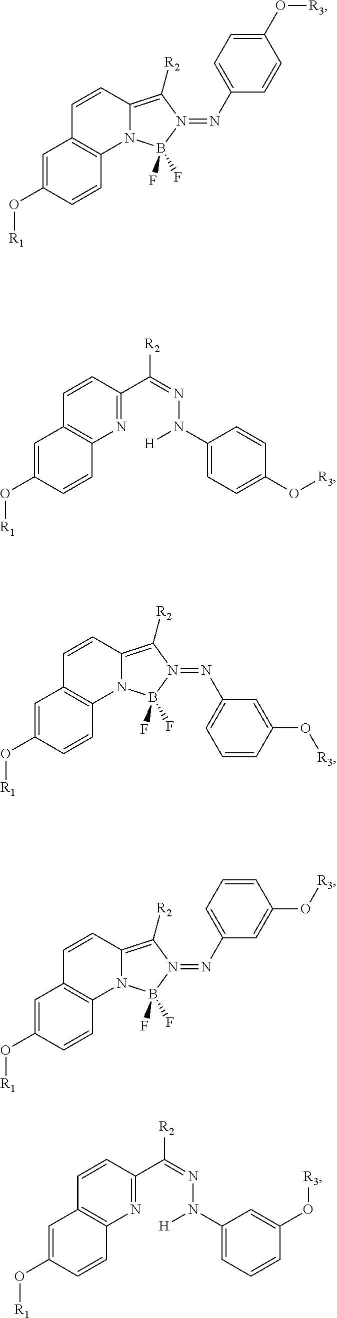

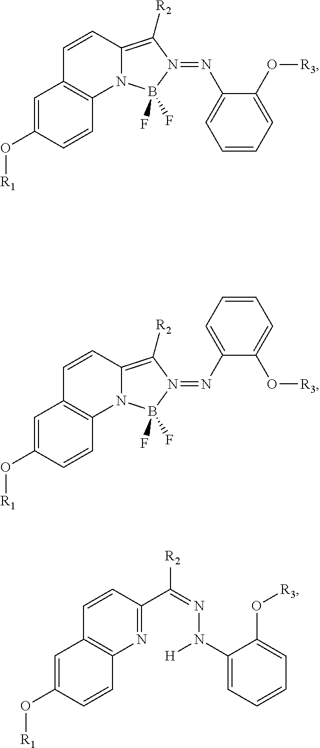

derivatives thereof, or combinations thereof.

Additional embodiments of the present disclosure pertain to the aforementioned compounds. Further embodiments of the present disclosure pertain to substrates that include the compounds of the present disclosure.

### FIGURES

FIG. 1A provides a schematic of possible reaction pathways by which azo-BF₂ 1 can be photoisomerized (trans/cis), thermally isomerized to yield a BF₂-hydrazone (BODIHY) 2, and/or revert back to hydrazone precursor 3.

FIG. 1B illustrates a method of changing a color of one or more regions of a substrate in accordance with various embodiments of the present disclosure.

FIG. 2 provides a multi-stimuli-responsive multicolor changes in a cross-linked polydimethylsiloxane (PDMS) film shaped into a clover. The transformation is of trans-1 using light and/or heat stimuli.

FIG. 3 provides another illustration of multi-stimuli-responsive multicolor changes in a cross-linked polydimethylsiloxane film that contain trans-AzoBF₂ diene.

FIGS. 4A-4H illustrate the photo and thermal switching of the azo-BF₂ switch in PDMS. FIG. 4A shows the structure of 1 and its trans and cis photoisomerization. FIG. 4B shows the three colors that can be accessed from thin films of PDMS doped 1 using light and/or heat stimuli. UV-Vis absorption spectra of a thin film of 1 under alternating 650 nm light irradiation followed by heat (373 K) treatment (FIG. 4C), or alternating 650 and 480 nm light irradiation (FIG. 4D). The insects show 10 cycles of the switching cycles. FIG. 4E shows photomasking experiments using alternating 650 nm irradiation and heating (373 K) starting from the blue-colored polymer canvas. FIG. 4F shows photomasking experiments using alternating 650 and 480 nm irradiations on the red-colored polymer canvas. Demonstration of the light penetration of 650 nm light by switching a PDMS rod (˜15 cm long) (FIG. 4G) and an object placed on top of a pig tissue (˜0.65 cm thickness) (FIG. 4H).

FIGS. 5A-5B show high-resolution patterning of PDMS films embedded with azo-BF₂ 1. Digital Light Processing patterning of photochromic polymers on the microscopic and macroscopic scale. FIG. 5A shows photographs of macroscopic images formed on a film of the photochromic polymer, including PDMS polymer structure, a dog named Moby, Dartmouth Hall, the Dartmouth Seal, and a tri-color image of a yin-yang. FIG. 5B shows photographs of microscopic images formed on a film of the photochromic polymer, including a checkerboard pattern, a rook chess piece, the SMU and Dartmouth logos, a tree-stump clip art, and Moby. Scale bars are 1000 μm.

FIGS. 6A-6B show animations in a solid photochromic polymer using the photo and thermal switching of 1. FIG. 6A shows a walking cat. FIG. 6B shows a growing spiral. The photochromic polymer slice is placed on a hot plate at 363 K and after the image fades, the second frame is patterned using red light. The process is repeated to generate successive frames.

FIGS. 7A-7C show a volumetric three-dimensional (3D) display inside of a solid polymer cube. FIG. 7A shows a polymer photochromic cube that is illuminated on one side (Side 1), leaving a square in the corner dark. A similar pattern is illuminated on another side (Side 5). After, a dark voxel will form in the corner of sides 1, 3, and 6. FIG. 7B shows photographs of sides 1, 3, and 6 of a cube illuminated as described earlier. FIG. 7C shows examples of volumetric 3D images of a solid pyramid, a wire-frame pyramid, SMU Peruna. and a face generated by artificial intelligence (AI).

### DETAILED DESCRIPTION

It is to be understood that both the foregoing general description and the following detailed description are illustrative and explanatory, and are not restrictive of the subject matter, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that include more than one unit unless specifically stated otherwise.

The section headings used herein are for organizational purposes and are not to be construed as limiting the subject matter described. All documents, or portions of documents, cited in this application, including, but not limited to, patents, patent applications, articles, books, and treatises, are hereby expressly incorporated herein by reference in their entirety for any purpose. In the event that one or more of the incorporated literature and similar materials defines a term in a manner that contradicts the definition of that term in this application, this application controls.

Adaptive materials that exhibit multi-chromic response as a function of applied stimulus are highly desirable. In particular, such systems can result in applications ranging from smart surfaces to anti-counterfeit devices. However, current adaptive materials exhibit limited multi-chromic responses.

For instance, volumetric three-dimensional (3D) displays offer a rich and comfortable user experience by rendering 3D images in a volume of space without the need for specialized glasses or headsets. As opposed to stereoscopic displays (e.g., virtual reality headsets), volumetric 3D displays are artistically and conceptually more akin to 3D sculptures than to two-dimensional (2D) paintings. Yet, despite the many advances in modern technology, there are limited easy-to-use volumetric media to sculpt, erase, and animate in 3D.

A need exists for the development of such 3D media. In particular, the ability to quickly shape spatially precise 3D images that can be simultaneously viewed by multiple viewers and viewing angles promises exciting applications not only for artistic endeavors, but also in medicine (e.g., diagnosis from 3D imaging data and planning surgeries), education (e.g., rendering 3D structures), and computer aided design (architectural planning), among many other applications.

Current state-of-the-art volumetric displays operate by either swept volume or static volume techniques. Swept volume displays typically use a screen that rapidly rotates or translates through a volume of space while a high-speed light source or projector is synchronized to project the appropriate 3D slice for each position of the screen. Examples of swept volume 3D displays that use a rapidly rotating array of LEDs are also known, as are active display units such as a static 3D array of light scattering centers.

Another class of volumetric 3D displays use laser tweezers or acoustic trapping of a particle that can be scanned through a volume of space and scatter light from a visible beam of light. However, challenges associated with maintaining long-term synchronization of moving components have limited commercialization of swept-volume architectures.

In comparison to swept-volume displays, static volume displays are in principle easier to implement and scale because of the relaxed mechanical requirements compared to sweeping a screen through a volume of space. An early example used two-photon luminescence of lanthanide-doped glasses to render an image at the intersection of high-power laser beams.

More recently, upconverting nanoparticles have been used in a similar strategy to implement volumetric 3D displays. The expense and safety hazards associated with the high intensity light sources as well as the fabrication of large crystals have limited the commercial potential of these types of displays.

Despite the idealized properties of volumetric 3D displays, there has never been an example of a hand-held volumetric 3D display where images can be sculpted, erased, and even animated. Such limits are due to a lack of readily available solid-state beam addressable materials to render 3D images.

Photochromic and other photoactive materials are particularly primed to address this disparity and have been used for holography, volumetric 3D printing, and volumetric 3D displays (albeit only in the liquid state with toxic solvents). Photochromic and photoactivatable volumetric 3D displays offer great advantages because they allow for the control of luminescence emission, for example, in a 3D space using low light power in a static matrix.

In sum, a need exists for improved adaptive materials that exhibit multi-chromic response as a function of applied stimulus. Numerous embodiments of the present disclosure address the aforementioned need.

### Methods of Changing a Color of a Substrate

In some embodiments, the present disclosure pertains to a method of changing a color of one or more regions of a substrate. In some embodiments, the methods of the present disclosure include applying at least one stimulus to the one or more regions of the substrate. In some embodiments, the one or more regions of the substrate includes one or more compounds that facilitate the color change.

### Compounds

The substrates of the present disclosure can include various compounds that can facilitate color change. Additional embodiments of the present disclosure pertain to such compounds. In some embodiments, the compounds of the present disclosure include, without limitation:

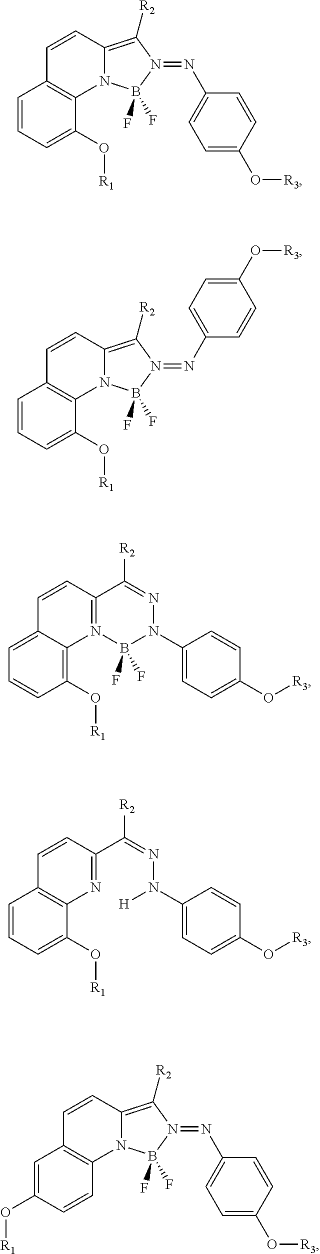

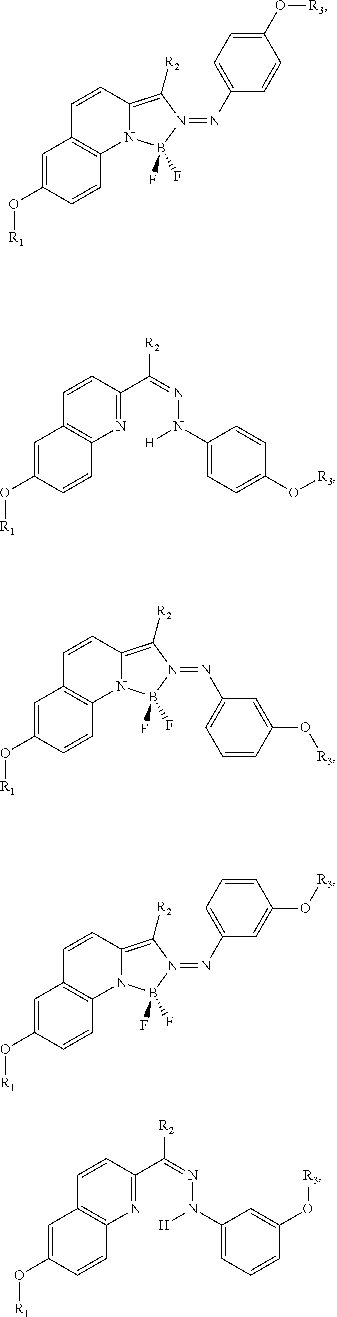

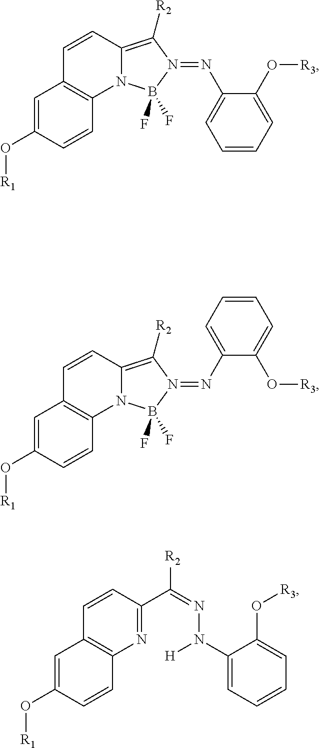

derivatives thereof, or combinations thereof.

In some embodiments, R₁, R₂ and R₃ each independently includes, without limitation, H, alkyl groups, alkenyl groups, alkyne groups, alkoxy groups, aryl groups, acrylic groups, ketone groups, amine groups, amide groups, carboxyl groups, carboxylic acid groups, ester groups, thiol groups, sulfoxide groups, alcohol groups, azide groups, CN, a methyl group, a polymer, a polymerizable group, a substrate component, or combinations thereof. In some embodiments, R₂ is CN.

In some embodiments, the compounds of the present disclosure include

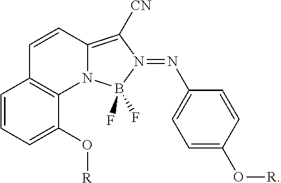

In some embodiments, R is

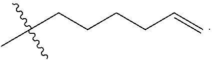 [SMILES: *CCCCC=C]

In some embodiments, the compounds of the present disclosure include

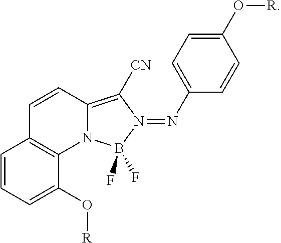

In some embodiments, R is

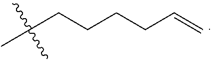 [SMILES: *CCCCC=C]

In some embodiments, the compounds of the present disclosure include

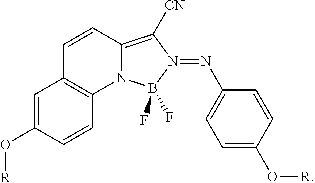

In some embodiments, R is

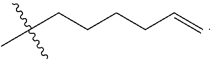 [SMILES: *CCCCC=C]

In some embodiments, the compounds of the present disclosure include

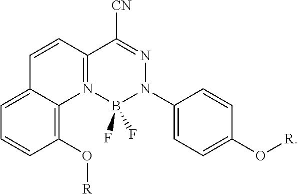

In some embodiments, R is

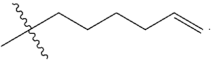 [SMILES: *CCCCC=C]

In some embodiments, the compounds of the present disclosure include

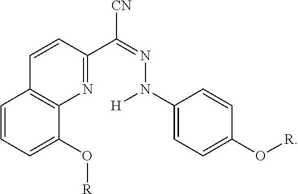

In some embodiments, R is

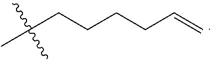 [SMILES: *CCCCC=C]

In some embodiments, the compounds of the present disclosure include

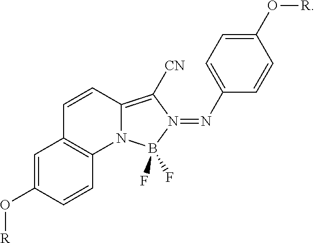

In some embodiments, R is

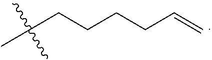 [SMILES: *CCCCC=C]

In some embodiments, the compounds of the present disclosure include

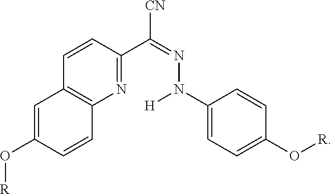

In some embodiments, R is

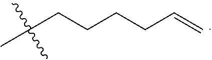 [SMILES: *CCCCC=C]

In some embodiments, the compounds of the present disclosure include

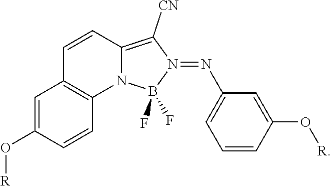

In some embodiments, R is

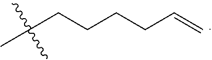 [SMILES: *CCCCC=C]

In some embodiments, the compounds of the present disclosure include

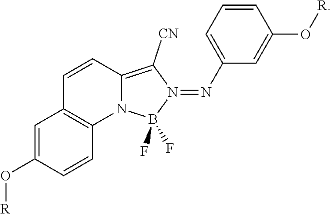

In some embodiments, R is

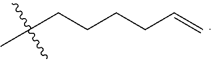 [SMILES: *CCCCC=C]

In some embodiments, the compounds of the present disclosure include

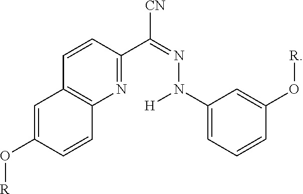

In some embodiments, R is

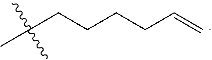 [SMILES: *CCCCC=C]

In some embodiments, the compounds of the present disclosure include

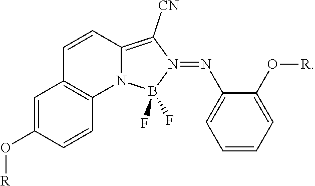

In some embodiments, R is

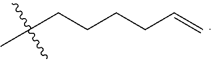 [SMILES: *CCCCC=C]

In some embodiments, the compounds of the present disclosure include

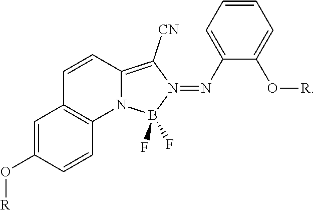

In some embodiments, R is

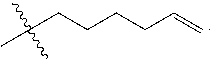 [SMILES: *CCCCC=C]

In some embodiments, the compounds of the present disclosure include

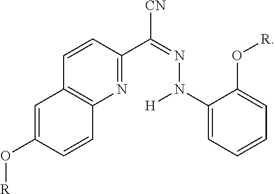

In some embodiments, R is

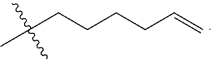 [SMILES: *CCCCC=C]

The compounds of the present disclosure may include various derivatives. In some embodiments, the derivative compounds include one or more moieties derivatized with one or more functional groups. In some embodiments, the one or more functional groups include, without limitation, alkyl groups, alkoxy groups, methyl groups, methoxy groups, amine groups, nitro groups, cyano groups, acyl groups, halogens, chlorine, fluorine, bromine, iodine, deuterium, alkanes, alkenes, ethers, alkynes, alkoxyls, aldehydes, carboxyls, hydroxyls, hydrogens, sulfurs, linkers, hydrogen groups, tracing agents, or combinations thereof.

### Stimuli

Substrates that contain the compounds of the present disclosure may be exposed to various types of stimuli. For instance, in some embodiments, the stimulus includes at least one of heat, light, darkness, or combinations thereof. In some embodiments, the stimulus is selected based on a desired outcome and color.

In some embodiments, the stimulus includes light. In some embodiments, the light includes a wavelength of at least 650 nm (i.e., 650 nm or higher). In some embodiments, the light includes a wavelength of at least 480 nm (i.e., 480 nm or higher). In some embodiments, the light includes a wavelength of about 350 nm to about 800 nm. In some embodiments, the wavelength of light is selected based on the structures of the compounds of the present disclosure. In some embodiments, the wavelength of light is selected based on a desired outcome and color.

In some embodiments, the stimulus includes light from a digital light projector. In some embodiments, the digital light projector is operable to provide native projection optics for macroscale patterning, microscopic optics for microscopic resolution patterning, or combinations thereof.

In some embodiments, the stimulus includes heat. In some embodiments, different heat temperatures have different color change effects on the one or more regions of a substrate. In some embodiments, the heat includes one or more temperatures ranging from about 300 K to about 400 K. In some embodiments, the heat includes a temperature of at least 338 K. In some embodiments, the heat includes a temperature of at least 373 K. In some embodiments, the temperature is selected based on a desired outcome and color.

In some embodiments, the stimulus includes darkness. In some embodiments, the stimulus includes light and heat. In some embodiments, the heat is applied from a heated surface. In some embodiment, the light is applied sequentially to the substrate to generate animations.

In some embodiments, the stimulus is applied in solution. In some embodiments, the stimulus is applied in solid state.

Without being bound by theory, the application of a stimulus may change the color of a substrate through various mechanisms. For instance, in some embodiments, a stimulus converts at least one of the compounds of the present disclosure to at least another of the compounds of the present disclosure. In some embodiments, the stimulus converts the configuration of the one or more compounds from a cis configuration to a trans configuration, or from a trans configuration to a cis configuration. In some embodiments, the conversion results in the changing of the color.

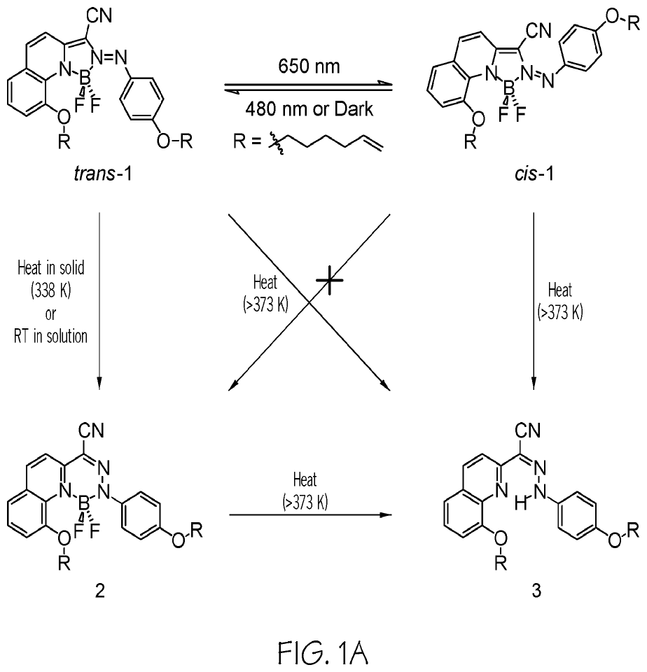

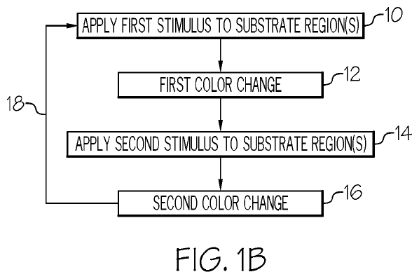

An example of the aforementioned mechanism is illustrated in FIG. 1A. For instance, as illustrated in FIG. 1A, heating of different compounds of the present disclosure at different temperatures can result in different compound conversions. Such different compound conversions at different temperatures can be utilized for desired outcomes and colors, such as achieving animation.

Stimuli may be applied to substrates in various manners. For instance, in some embodiments, the same stimulus is applied to different regions of a substrate. In some embodiments, the same stimulus is applied to the same regions of a substrate. In some embodiments, different stimuli are applied to different regions of a substrate to result in different color changes in the different regions of the substrate. In some embodiments, different stimuli are applied to the same regions of a substrate to result in different color changes in the same regions of the substrate.

In some embodiments, different stimuli are applied sequentially to the different regions of the substrate. Examples of the aforementioned embodiments are illustrated in FIGS. 1B, 2-3, 4A-4H, 5A-5B, 6A-6B, and 7A-7C.

In some embodiments, the application of a stimulus to one or more regions of substrate includes: (1) applying a first stimulus to one or more regions of the substrate such that the first stimulus changes the color of the one or more regions of the substrate; and (2) applying a second stimulus to the one or more regions of the substrate after the application of the first stimulus such that the application of the second stimulus reverses the change in the color of the one or more regions of the substrate. In some embodiments, the first stimulus includes light and the second stimulus includes heat. In some embodiments, the first stimulus includes light at a first wavelength, and the second stimulus includes light at a second wavelength. In some embodiments, the first wavelength is about 650 nm, and the second wavelength is about 480 nm.

In some embodiments illustrated in FIG. 1B, the application of a stimulus to one or more regions of a substrate includes: (1) applying a first stimulus to the one or more regions of the substrate (step 10) such that the first stimulus changes the color of the one or more regions to a first color (step 12); and (2) applying a second stimulus to the one or more regions of the substrate (step 14) such that the second stimulus changes the color of the one or more regions of the substrate to a second color (step 16). In some embodiments, the aforementioned steps may be repeated multiple times (step 18). In some embodiments, each of the first and second stimuli independently include, without limitation, light, heat, or combinations thereof. In some embodiments, the first stimulus and the second stimulus are applied to the same region of a substrate. In some embodiments, the first stimulus and the second stimulus are applied to different regions of a substrate.

### Changes in Color

The methods of the present disclosure may be utilized to change the color of substrates to different colors. For instance, in some embodiments, the application of a stimulus to one or more regions of a substrate forms a color pattern on the substrate. In some embodiments, the change in color includes a change in color to red, green, purple, pink, orange, yellow, blue, or combinations thereof.

In some embodiments, the change in color is reversible. For instance, in some embodiments, the color may change after a certain period of time. In some embodiments, the change in color is reversible upon the application of another stimulus to the substrate. In some embodiments, the change in color is in the form of a pattern on the substrate. In some embodiments, such as embodiments involving high heat conditions, the color change is irreversible.

### Substrates

The methods of the present disclosure may apply stimuli to various substrates. Additional embodiments of the present disclosure pertain to such substrates.

The substrates of the present disclosure generally include one or more compounds of the present disclosure. In some embodiments, the substrates of the present disclosure are embedded with one or more compounds of the present disclosure. In some embodiments, one or more compounds of the present disclosure are embedded with the substrate. In some embodiments, the compounds of the present disclosure are embedded with the substrate through one or more of the R, R₁, R₂, or R₃ groups.

In some embodiments, the substrates of the present disclosure include a plurality of different regions. In some embodiments, each of the plurality of different regions are associated with one or more compounds of the present disclosure.

In some embodiments, different regions of a substrate include different compounds of the present disclosure. In some embodiments, the different compounds facilitate different changes of color upon the application of a stimulus.

In some embodiments, different regions of a substrate include the same compounds of the present disclosure. In some embodiments, the same compounds facilitate same changes of color upon the application of a stimulus. In some embodiments, the same compounds facilitate different changes of color upon the application of different stimuli.

The methods of the present disclosure may be utilized to change the color of various substrates. For instance, in some embodiments, the substrate includes, without limitation, a film, a display panel film, a mask surface, a polymer, a polydimethylsiloxane film, a display screen, a window film, a sunglass lens, a glass film, a paper, a three-dimensional substrate, a solid-state substrate, or combinations thereof.

In some embodiments, the substrates of the present disclosure include a solid-state substrate. In some embodiments, the substrate is in the form of a three-dimensional substrate. In some embodiments, the substrate is in the form of a three-dimensional and solid-state substrate. In some embodiments, the three-dimensional substrate is in the form of a cube. In some embodiments, the three-dimensional substrate includes a plurality of sides. In some embodiments, the stimulus is applied to at least one of the plurality of sides to render a three-dimensional pattern. In some embodiments, the stimulus includes light from a digital light projector.

In some embodiments, the substrate includes a plurality of different regions. In some embodiments, each of the plurality of different regions are associated with one or more compounds of the present disclosure. In some embodiments, different regions of a substrate may include different compounds of the present disclosure. As such, in some embodiments, the different compounds facilitate different changes of color upon the application of the stimulus.

In some embodiments, different regions of a substrate may include the same compounds of the present disclosure. In some embodiments, the same compounds facilitate the same changes of color upon the application of the stimulus. In some embodiments, the same compounds facilitate different changes of color upon the application of different stimuli.

In some embodiments, the methods of the present disclosure also include a step of applying the one or more compounds of the present disclosure to one or more regions of a substrate. In some embodiments, the applying occurs by methods that include, without limitation, spraying, doping, embedding, covalent bonding, in situ formation, or combinations thereof.

### Applications

The methods of the present disclosure can have numerous applications. For instance, in some embodiments, the methods of the present disclosure may be utilized for temperature sensing, authentication, counterfeit monitoring, pattern formation, display of information, or combinations thereof.

### ADDITIONAL EMBODIMENTS

Reference will now be made to more specific embodiments of the present disclosure and experimental results that provide support for such embodiments. However, Applicant notes that the disclosure below is for illustrative purposes only and is not intended to limit the scope of the claimed subject matter in any way.

### Example 1. Fabrication and Use of Azo-BF₂ Derivatized Compounds in Adaptive Polymers

As illustrated in FIGS. 1A and 2-3, Applicant used azo-BF₂ derivatized compounds to make adaptive polymers that can in one instance change their color as a function of light and heat.

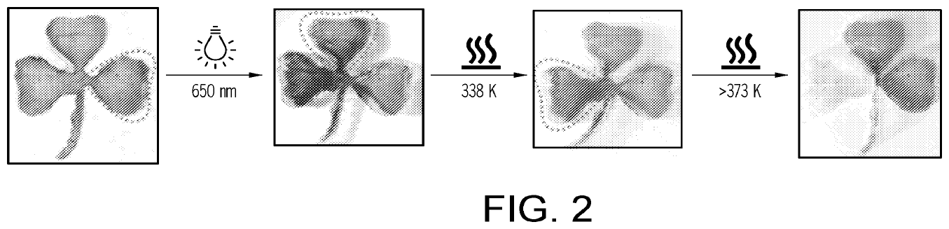

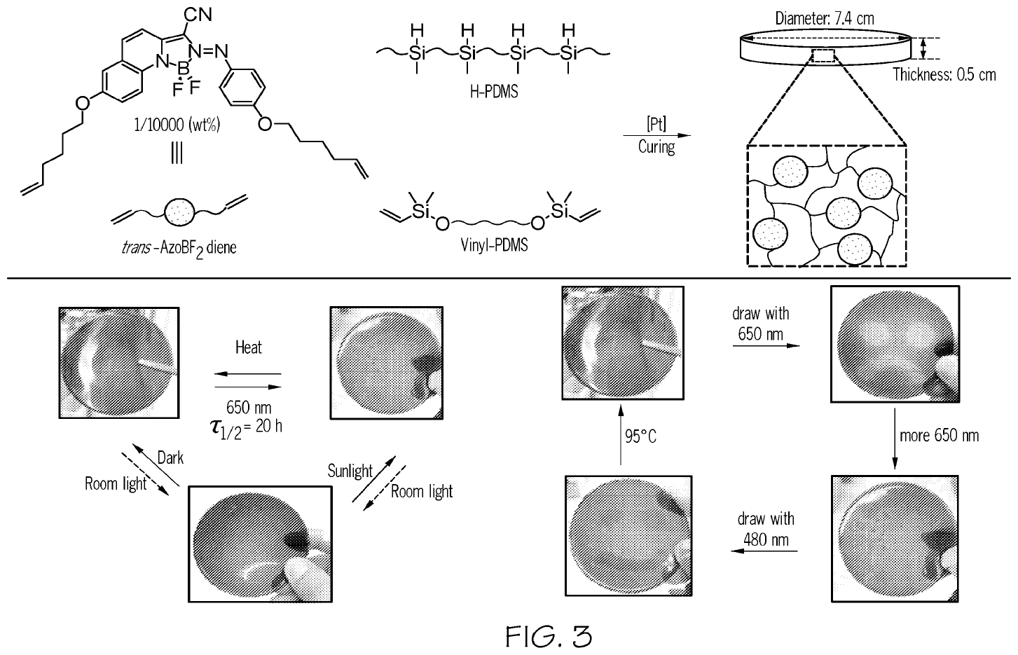

As illustrated in FIG. 3, a derivative of the azo-BF₂ compound was embedded into a polymer. The compound was thermally stable and did not undergo the azo-BF₂ to BODIHY dye or hydrazone conversion reaction. High temperature only resulted in accelerating the cis to trans isomerization. One of the intriguing parts of the compound is that it has very fast thermal and photo responses and can use thick films for the function.

Because Applicant can access thick films, Applicant can also print 3D printed images in the polymers. A benefit of Applicant's system is that it can be erased, and the polymer reused (FIGS. 2-3). Applicant can also make movies that can be animated on the polymer.

Another advantage of this Example is that the azo-BF₂ compound can be activated with red and near infrared light while being negatively photochromic. These combined properties allow Applicant to perform photo-switching in very thick polymer films, which is unprecedented.

The multi-chromicity and the use of fast heat and light switching to have animation of polymer surfaces is a new concept. Applicant can activate very thick polymers through the utilization of simple light.

### Example 2. Rewritable Hand-Held Volumetric 3D Displays Using Azo-BF₂ Switches

The use of photochromic materials in holography or volumetric three-dimensional (3D) displays can open the way of immersive visual experiences by representing 3D content that appears to occupy real physical space. Applicant discovered that doping visible-light activated azo-BF₂ switches into PDMS polymers can result in volumetric beam-addressable canvases. The straightforward manipulation of the canvas with red and blue light illumination using digital light processing and/or heat (i.e., thermal back isomerization) generates tunable, reversible, and high contrast and resolution color-switching. These properties were used in designing a rewritable, solid-state, and hand-held volumetric 3D photochromic display that can be reversibly used for showcasing 3D images and 2D animations. In particular, in this Example, Applicant demonstrates that the doping of negatively photochromic red-light activated azo-BF₂ in a polymer matrix enables the development of a solid-state, hand-held 3D volumetric display in which information can be erased and re-written on demand.

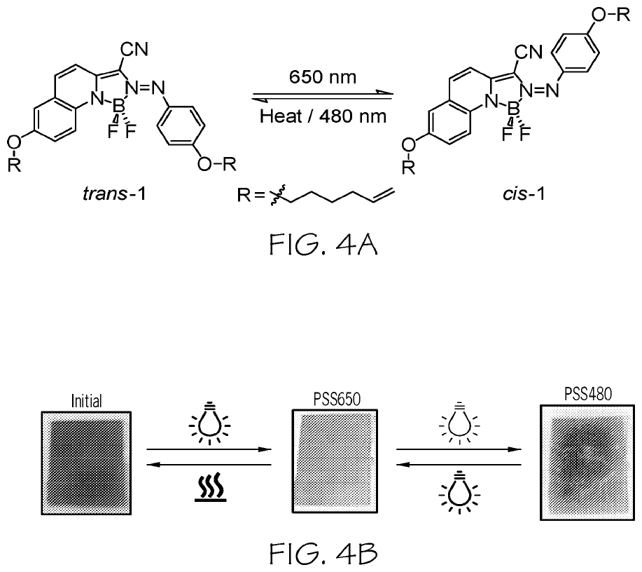

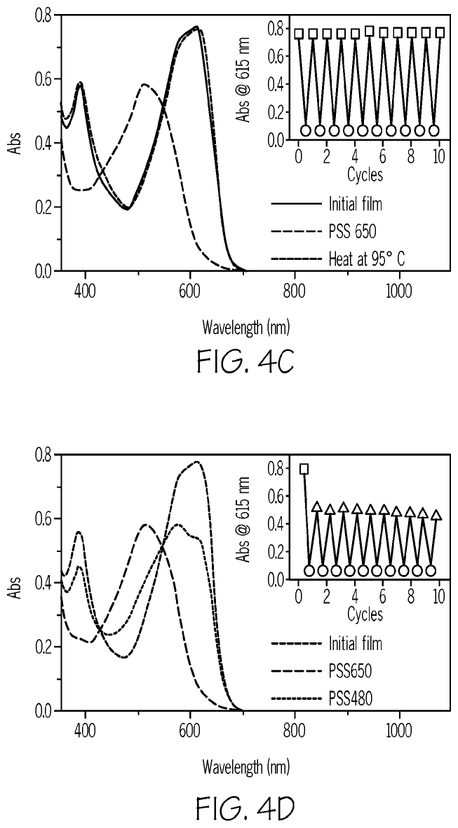

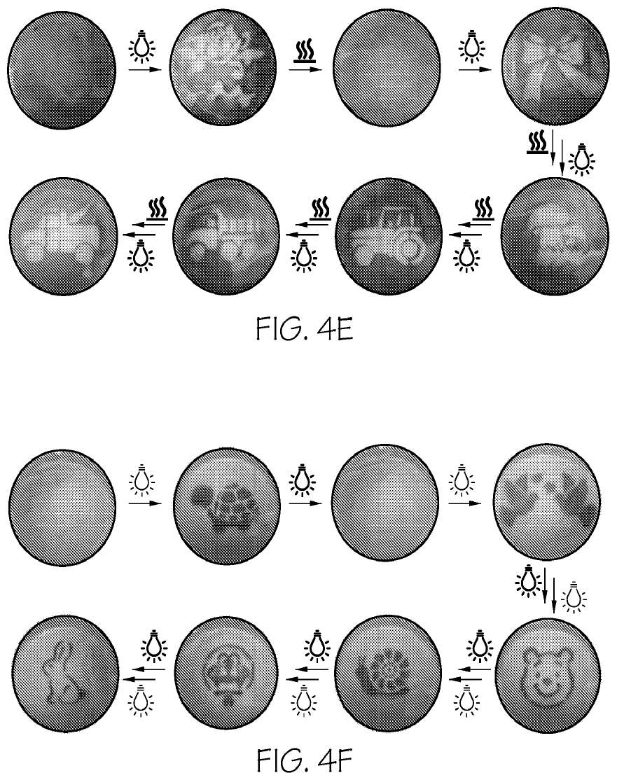

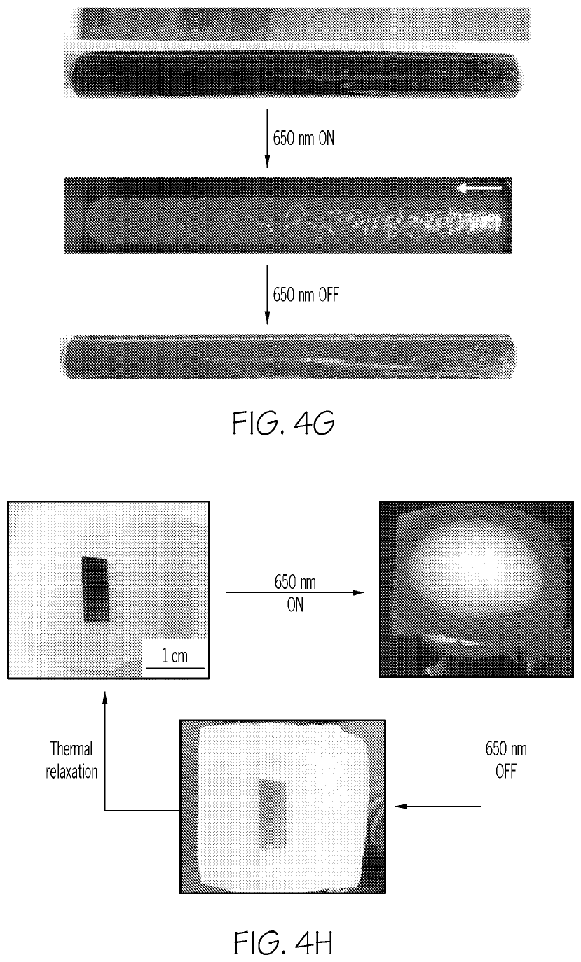

Applicant has developed a rewritable, solid-state, and hand-held volumetric 3D photochromic display by embedding newly developed visible-light activated azo-BF₂ switches (FIG. 4A) into polydimethylsiloxane (PDMS) based polymers to create a volumetric beam-addressable 3D canvas for images and animation. The PDMS polymer with the embedded azo-BF₂ switch shows stimuli-responsive tricolor reflection (blue, red, and purple; FIG. 4B) that can be used in high-contrast color manipulations. The use of either red (650 nm) or blue (480 nm) light illumination in conjunction with negative photochromicity and controlled thermal back isomerization results in excellent tunability and reversibility. These properties, especially the red-light activation, enable switching of very thick polymers (up to a half a foot in width), which has been a bottleneck in this field, the high-resolution photomasking of objects, digital light processing (DLP) formation of images and animation, and finally volumetric 3D image generation with photographic detail in thick polymer blocks. Notably, this is the first report of a hand-held solid-state volumetric 3D photochromic display capable of rendering high-resolution photograph quality images that can be easily erased and rewritten.

The visible-light responsive switch azo-BF₂ 1 was synthesized in 60% yield by reacting an appropriate hydrazone precursor with boron trifluoride diethyl etherate in the presence of N,N-diisopropylethylamine. The terminal alkene chains on both sides of 1 were incorporated for subsequent polymer crosslinking. The azo-BF₂ switch 1 and all its precursors were fully characterized using NMR spectroscopy, mass spectrometry and X-ray crystallography.

The photoisomerization performance of 1 in dichloromethane (DCM) was studied using UV-Vis and NMR spectroscopies. Switch 1 adopts the thermodynamically stable trans-form in the dark (88%) with the maximum UV-Vis absorbance (λₘₐₓ) being at 597 nm (ε28,900 M⁻¹ cm⁻¹). Upon irradiation with 650 nm light the cis isomer (λₘₐₓ=525 nm; ε=20,300 M⁻¹ cm⁻¹) becomes dominant, accompanied by a drastic change in the color of the solution from blue to red. The photostationary state (PSS₆₅₀=92% cis) and quantum yield (Φ_{trans→cis}=47%) show that the photoisomerization is efficient. Irradiation of the cis-rich solution with 480 nm yields a PSS₄₈₀ of 56% trans and Φ_{cis→trans} of 64%, along with a color change from red to purple. The low PSS₄₈₀ value for the back photoisomerization results from the overlap of the absorption bands of the two isomers. The thermal half-life (τ_{1/2}) of the metastable cis-1 in DCM (4×10⁻⁵ M) was measured to be 12 min at 294 K.

Next, Applicant studied the photochromic properties of 1 in PDMS (FIGS. 4C-4H). Installing 1 into a PDMS matrix was accomplished by co-crosslinking the prepolymers via a heat-curing process. The UV-Vis absorption band of the initial trans-1 rich thin film, which is less broad than the one obtained in solution because of the rigidity of the medium, undergoes a hypochromic shift from 614 to 514 nm upon 650 nm irradiation (FIGS. 4B-4C). The thus obtained cis absorption band reverts to the initial state after heating at 373 K for 1 min. The color of the polymer changes during this photo-thermal process from the initial blue (trans rich) to red (cis rich) and then back to blue. Because of the overlap between the trans and cis absorption bands, irradiating the cis-rich film with 480 nm results in a trans/cis mixture that yields a purple color. The photo-switching process in the polymer can be cycled many times photothermally and photochemically (FIG. 4D) with minimal signs of (photo) degradation.

To take advantage of the deep penetration of red light, Applicant tested the photo-switching process (FIGS. 4E and 4F) in a thick “coaster”-shaped polymer (thickness: 0.5 cm, diameter 7.4 cm). Applicant used a 650 nm light and different shaped photomasks to draw different, red-colored shapes on the initially blue canvas (FIG. 4E). Heating the polymer erases the writing and reverts the canvas back to blue allowing for the easy repetition of the process 10 times. Exposing the whole disk to 650 nm light turns the “coaster” red, and now blue light (480 nm) can be used to draw on the canvas, resulting in purple shapes (FIG. 4F). These shapes can be erased using red light, allowing for multiple repetitions of this draw/erase cycle. To further demonstrate the benefits of red-light activation (i.e., deep penetration through materials and tissue) in conjunction with negative photochromicity, Applicant used 650 nm red light to completely switch a ˜15 cm (˜0.5 ft) thick PDMS rod (FIG. 4G), and a polymer piece placed on top of a ˜0.65 cm thick pig skin while illuminating from underneath (FIG. 4H).

UV-Vis absorption kinetics analysis of thin films of 1 show that the thermal half-life (τ_{1/2}) of the metastable cis-1 film is ca. 20 h under dark at 294 K, which is much longer than in solution (ca. 12 min) most likely because of the physical constraints of the more condensed medium. The reverse isomerization can be greatly accelerated using heat with τ_{1/2} being as short as 0.7 s at 413 K. The elevated temperature studies also demonstrated the great thermal stability of the thin films of 1, while thermal gravimetric analysis of trans-1 powders showed less than 0.4% thermal decomposition occurring during the experiment (240 minutes) at 373 K.

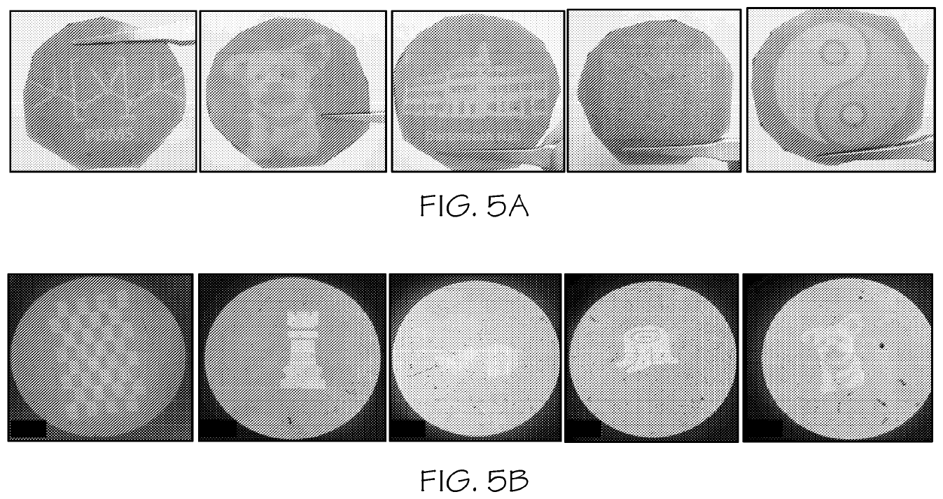

Given the optimal attributes of this solid photochromic material, Applicant used macroscopic and microscopic digital light processing (DLP) techniques to investigate the limits of resolution, animations in the solid state, and rewritable 3D volumetric images in a hand-held medium. Arbitrary patterns at the macroscopic and microscopic scale were generated using the digital micromirror device (DMD) and light engine of a LightCrafter 4500 coupled with the appropriate projection optics. On the macroscale, the native projection optics were used to generate high-resolution, photograph quality images in the solid photochromic material, including chemical structures, a picture of the dog Moby (group mascot), buildings, an academic seal, and a tricolor (blue, red, and purple) yin-yang (FIG. 5A). For microscopic patterning, a DLP fluorescence microscope using the DMD chip and light engine of a LightCrafter 4500 was used to direct patterned light through a microscope objective. Line widths as low as 18 μm could be readily patterned and observed, and examples of microscopic patterning include a checkerboard, chess pieces, SMU and Dartmouth Logos, a clip-art tree stump, and once again Moby (FIG. 5B).

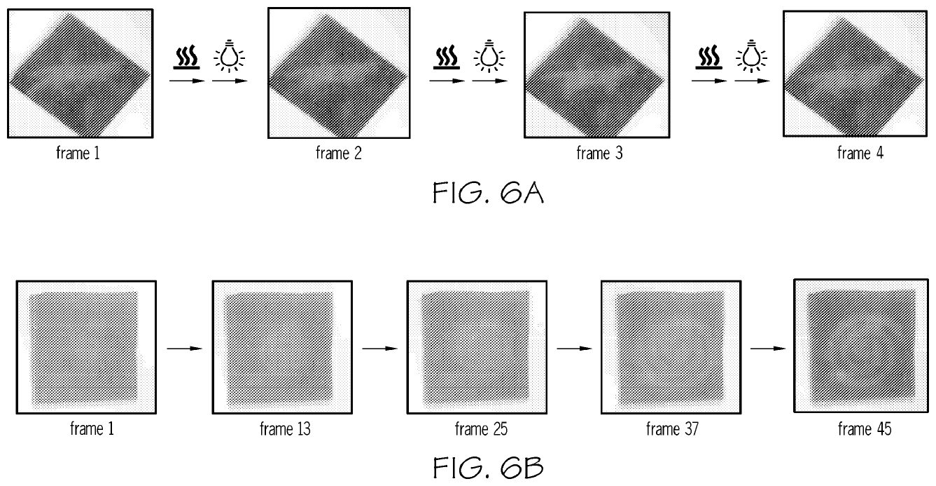

Next, Applicant took advantage of the fast thermal fading at elevated temperatures to perform animations in the solid photochromic rectangular prism. A slice of the photochromic film was placed on a hot plate set at 90° C., and the light from a DLP projector was directed towards the film using a mirror. An image was patterned using 20 seconds of photoactivation, a 1 second pause to capture a frame and then another round of photoactivation to pattern the next frame. An example is shown in FIG. 6A, where four frames of a walking cat animation produced in this way are shown, with the time-lapsed animation.

A second example of a growing spiral is shown in FIG. 6B, where every fourth frame of the animation is depicted, showing a spiral growing from the center of the solid photochromic material. While the frame rate in these animations (0.33 fps) is low compared to the standard 24 fps for movies and streaming content, it is important to note that the internal molecular properties of a solid polymer material are being precisely and reversibly patterned with high spatial resolution in real-time. This discovery has profound implications for advanced materials applications.

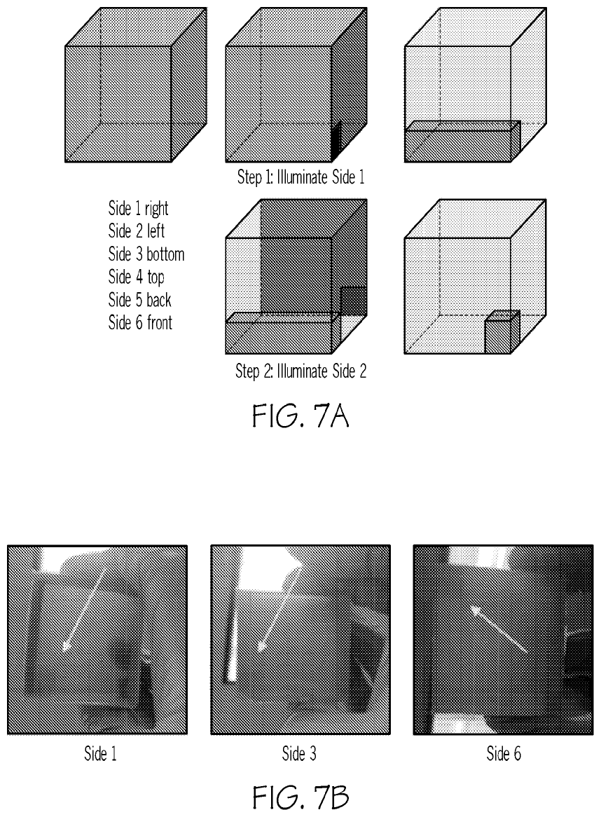

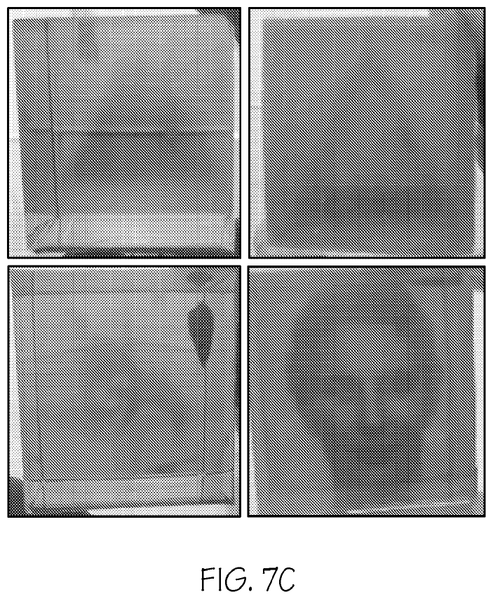

Applicant then turned towards the formation of volumetric 3D images in the solid polymer display. To demonstrate the feasibility of the technique, Applicant formed voxels in the corner of the 3×3 inch cube by illuminating one side with a uniform red pattern except for a square in the corner, which was not illuminated (FIG. 7A). This leads to a rectangular prism of blue material in a background of red. The cube is then illuminated from another side with the same pattern so that all the blue rectangular prism is converted to red, except for a cubic voxel in the corner. Implementation of this strategy enables formation of voxels of ˜0.5 cm² as can be seen in the photographs shown in FIG. 7B.

Using the aforementioned strategy, and by taking advantage of the reversibility of the process, Applicant then proceeded to generate different 3D images in the solid-state hand-held display. Illumination with a triangle pattern from two sides generates a 3D pyramid in the display (FIG. 7C). Applicant investigated different concentrations (wt %) of the photo-switch, including 0.01%, 0.0025%, and 0.0018%. Generally, there is a tradeoff of image opacity versus the transparency of the display, with optimal contrast achieved with 0.0025% of the photo-switch.

Importantly, the same cube can be readily reset by placing the polymer in an oven at 363 K for 30 minutes, allowing 3D writing, erasing, and re-writing. This was demonstrated by rendering multiple volumetric 3D images, including the solid 3D pyramid, a hollow 3D wire-frame pyramid, and the SMU Peruna mascot as a 2D slice of defined thickness at a controlled depth within the cube. Finally, Applicant illuminated the solid-state 3D display with a face generated via artificial intelligence (FIG. 7C) to demonstrate that photograph quality images of faces can be rendered at given 3D positions within this hand-held display.

In summary, Applicant has demonstrated how red-light activation of photo-switches, when combined with an appropriate polymer matrix, results in a fundamental leap empowering solid-state animation and 3D volumetric display application technologies. The reversibility of the handheld-display opens the door for applications ranging from medical diagnostics to toys, while the animation in the film suggests that such displays can in the future, be used to represent adaptive 3D structures as well.

Without further elaboration, it is believed that one skilled in the art can, using the description herein, utilize the present disclosure to its fullest extent. The embodiments described herein are to be construed as illustrative and not as constraining the remainder of the disclosure in any way whatsoever. While the embodiments have been shown and described, many variations and modifications thereof can be made by one skilled in the art without departing from the spirit and teachings of the invention. Accordingly, the scope of protection is not limited by the description set out above, but is only limited by the claims, including all equivalents of the subject matter of the claims. The disclosures of all patents, patent applications and publications cited herein are hereby incorporated herein by reference, to the extent that they provide procedural or other details consistent with and supplementary to those set forth herein.

What is claimed is:

1. A method of changing a color of one or more regions of a substrate, said method comprising:
applying at least one stimulus to the one or more regions of the substrate,
wherein the one or more regions of the substrate comprises one or more compounds selected from the group consisting of 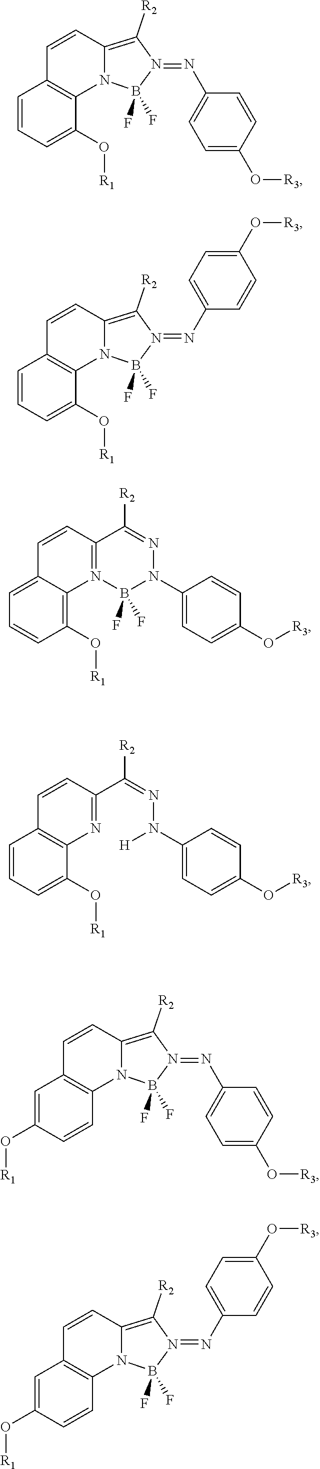 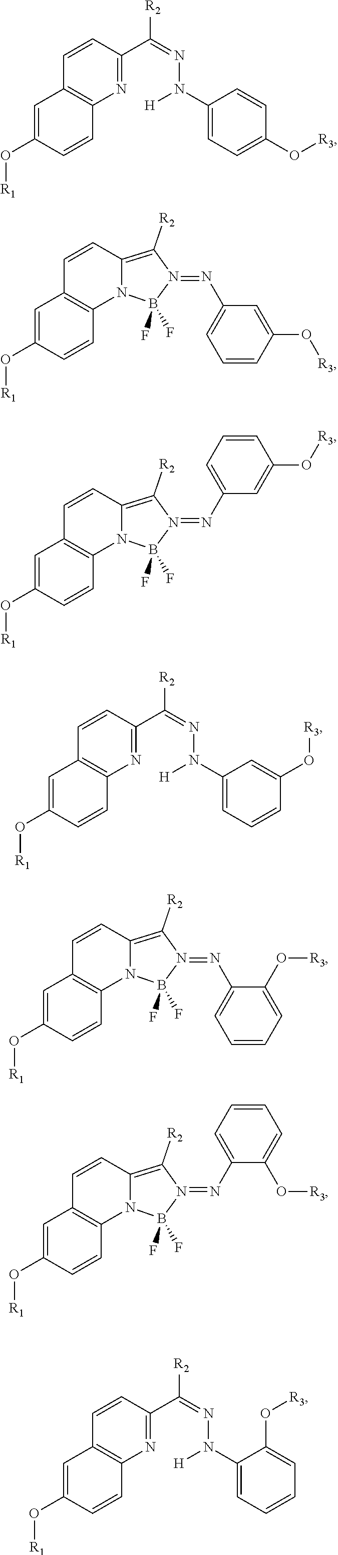
derivatives thereof, or combinations thereof,
wherein R₁, R₂ and R₃ are each independently selected from the group consisting of H, alkyl groups, alkenyl groups, alkyne groups, alkoxy groups, aryl groups, acrylic groups, ketone groups, amine groups, amide groups, carboxyl groups, carboxylic acid groups, ester groups, thiol groups, sulfoxide groups, alcohol groups, azide groups, CN, a methyl group, a polymer, a polymerizable group, a substrate component, or combinations thereof.

2. The method of claim 1, wherein the one or more compounds comprises 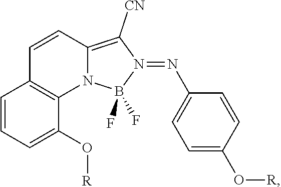
wherein R comprises

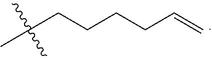 [SMILES: *CCCCC=C]

3. The method of claim 1, wherein the one or more compounds comprises 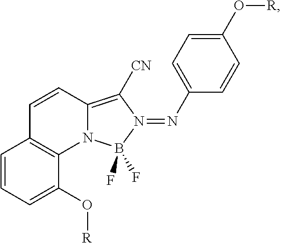
wherein R comprises

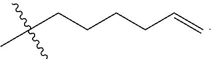 [SMILES: *CCCCC=C]

4. The method of claim 1, wherein the one or more compounds comprises 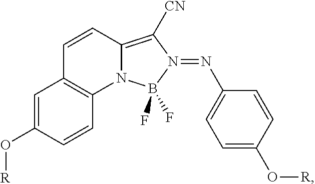
where R comprises

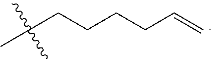 [SMILES: *CCCCC=C]

5. The method of claim 1, wherein the one or more compounds comprises 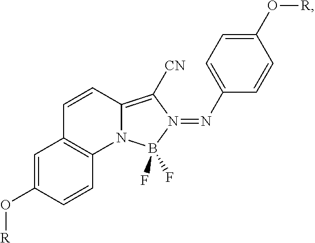
where R comprises

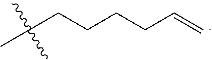 [SMILES: *CCCCC=C]

6. The method of claim 1, wherein the stimulus comprises at least one of heat, light, darkness, or combinations thereof.

7. The method of claim 1, wherein the stimulus comprises light.

8. The method of claim 1, wherein the stimulus comprises light from a digital light projector, wherein the digital light projector is operable to provide native projection optics for macroscale patterning, microscopic optics for microscopic resolution patterning, or combinations thereof.

9. (canceled)

10. The method of claim 1, wherein the stimulus comprises heat.

11. The method of claim 1, wherein the stimulus comprises darkness.

12. The method of claim 1, wherein the stimulus comprises light and heat.

13. The method of claim 12, wherein the heat is applied from a heated surface, and wherein the light is applied sequentially to the substrate to generate animations.

14. The method of claim 1, wherein the stimulus converts the configuration of the one or more compounds from a cis configuration to a trans configuration, or from a trans configuration to a cis configuration, and wherein the conversion results in the changing of the color.

15. The method of claim 1, wherein the application of the stimulus forms a color pattern on the substrate.

16. The method of claim 1, wherein the same stimulus is applied to different or the same regions of the substrate.

17. (canceled)

18. The method of claim 1, wherein different stimuli are applied to different regions of the substrate to result in different color changes in the different regions of the substrate, wherein different stimuli are applied to the same regions of the substrate to result in different color changes in the same regions of the substrate, or combinations thereof.

19. (canceled)

20. The method of claim 1, wherein the change in color comprises a change in color to red, green, purple, pink, orange, yellow, blue, or combinations thereof.

21. The method of claim 1, wherein the change in color is in the form of a pattern on the substrate.

22. The method of claim 1, wherein the change in color is reversible upon the application of another stimulus to the one or more regions of the substrate.

23. The method of claim 1, wherein the applying of the at least one stimulus to the one or more regions of the substrate comprises:
applying a first stimulus to the one or more regions of the substrate, wherein the first stimulus changes the color of the one or more regions of the substrate; and
applying a second stimulus to the one or more regions of the substrate, wherein the application of the second stimulus occurs after the application of the first stimulus to the substrate, and wherein the application of the second stimulus reverses the change in the color of the one or more regions of the substrate.

24. The method of claim 23, wherein the first stimulus comprises light, and wherein the second stimulus comprises heat.

25. The method of claim 23, wherein the first stimulus comprises light at a first wavelength, and wherein the second stimulus comprises light at a second wavelength, wherein the first wavelength is about 650 nm, and wherein the second wavelength is about 480 nm.

26. (canceled)

27. The method of claim 1, wherein the applying of the stimulus to the one or more regions of the substrate comprises:
applying a first stimulus to the one or more regions of the substrate, wherein the first stimulus changes the color of the one or more regions of the substrate to a first color; and
applying a second stimulus to the one or more regions of the substrate, wherein the application of the second stimulus changes the color of the one or more regions of the substrate to a second color.

28. The method of claim 27, wherein each of the first and second stimuli are independently selected from the group consisting of light, heat, or combinations thereof.

29. The method of claim 27, wherein the first stimulus and the second stimulus are applied to the same region of the substrate, or wherein the first stimulus and the second stimulus are applied to different regions of the substrate.

30. (canceled)

31. The method of claim 1, wherein the substrate comprises a plurality of different regions, wherein each of the plurality of different regions are associated with the one or more compounds of claim 1, wherein the different regions of the substrate comprise different or the same compounds of claim 1, and wherein the different compounds facilitate different or the same changes of color upon the application of the stimulus.

32-35. (canceled)

36. The method of claim 1, wherein the one or more compounds are embedded with the substrate.

37. The method of claim 1, wherein the substrate comprises a solid-state substrate.

38. The method of claim 1, wherein the substrate is in the form of a three-dimensional and solid state substrate, wherein the three-dimensional substrate comprises a plurality of sides, wherein the stimulus is applied to at least one of the plurality of sides to render a three-dimensional pattern.

39-41. (canceled)

42. The method of claim 38, wherein the stimulus comprises light from a digital light projector.

43. The method of claim 1, further comprising a step of applying the one or more compounds to the one or more regions of the substrate, wherein the applying occurs by a method selected from the group consisting of spraying, doping, embedding, covalent bonding, in situ formation, or combinations thereof.

44. (canceled)

45. The method of claim 1, wherein the method is utilized for temperature sensing, authentication, counterfeit monitoring, pattern formation, display of information, or combinations thereof.

46. A substrate embedded with one or more compounds, wherein the one or more compounds are selected from the group consisting of 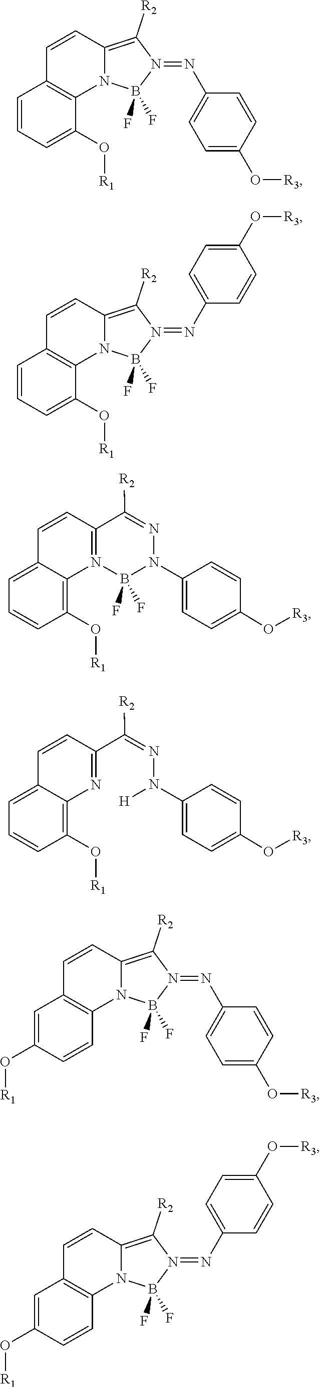 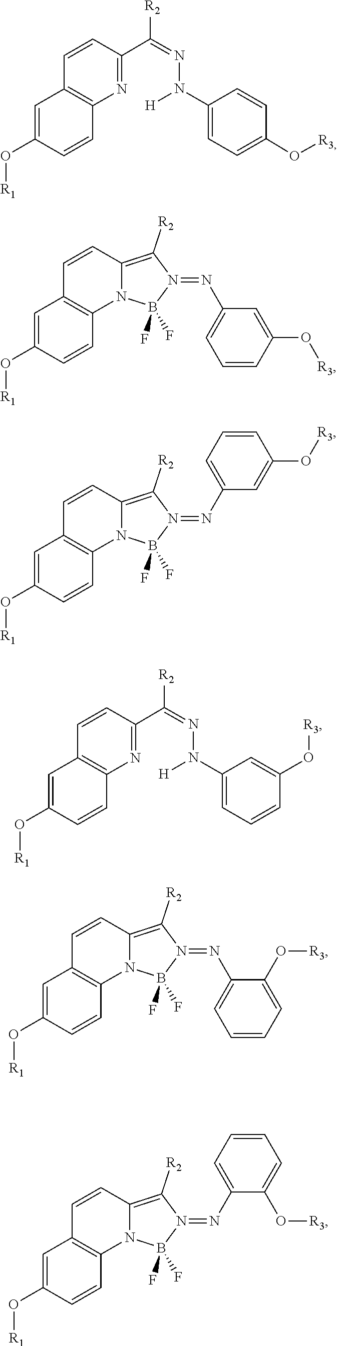 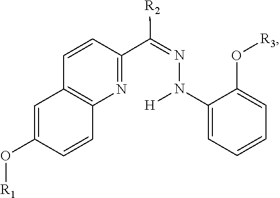
derivatives thereof, or combinations thereof,
wherein R₁, R₂ and R₃ are each independently selected from the group consisting of H, alkyl groups, alkenyl groups, alkyne groups, alkoxy groups, aryl groups, acrylic groups, ketone groups, amine groups, amide groups, carboxyl groups, carboxylic acid groups, ester groups, thiol groups, sulfoxide groups, alcohol groups, azide groups, CN, a methyl group, a polymer, a polymerizable group, a substrate component, or combinations thereof.

47. The substrate of claim 46, wherein the one or more compounds comprises 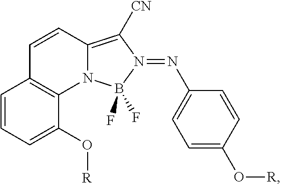
wherein R comprises

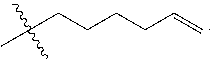 [SMILES: *CCCCC=C]

48. The substrate of claim 46, wherein the one or more compounds comprises 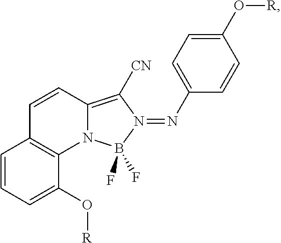
wherein R comprises

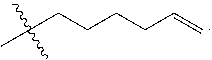 [SMILES: *CCCCC=C]

49. The substrate of claim 46, wherein the one or more compounds comprises 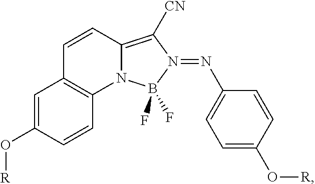
where R comprises

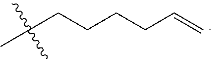 [SMILES: *CCCCC=C]

50. The substrate of claim 46, wherein the one or more compounds comprises 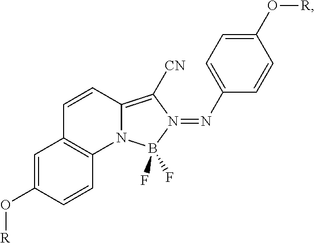
where R comprises

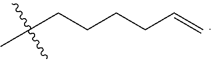 [SMILES: *CCCCC=C]

51. The substrate of claim 46, wherein the substrate comprises a plurality of different regions, wherein each of the plurality of different regions are associated with the one or more compounds of claim 46, and wherein the different regions of the substrate comprise different or the same compounds of claim 46.

52-54. (canceled)

54. The substrate of claim 46, wherein the substrate comprises a solid-state and three-dimensional substrate, and wherein the three-dimensional substrate comprises a plurality of sides.

55-58. (canceled)
